(19) United States
(12) Patent Application Publication
(10) Pub. No.: US 2024/0045127 A1
(43) Pub. Date: Feb. 8, 2024

(54) PHASE RETARDING APPARATUS, PREPARATION METHOD THEREFOR, AND DISPLAY DEVICE

(71) Applicant: BEIJING RAYBOCH TECHNOLOGY CO., LTD., Beijing (CN)

(72) Inventor: Wenqing ZHAO, Chengdu (CN)

(21) Appl. No.: 18/269,991

(22) PCT Filed: Dec. 13, 2021
(86) PCT No.: PCT/CN2021/137388

§ 371 Date: Jun. 28, 2023

(30) Foreign Application Priority Data
Dec. 28, 2020 (CN) 202011573836.2

(51) Int. Cl. G02B 5/30; G02F 1/13363; G02F 1/1337; G02F 1/1335

(52) U.S. Cl. CPC G02B 5/3083; G02F 1/13363; G02F 1/1337; G02F 1/133528

(57) ABSTRACT

A phase retarding apparatus and a preparation method therefor, and a display device. The phase retarding apparatus comprises a first polarizing layer (200), a first phase retarding layer (300), a second phase retarding layer (400) and a second polarizing layer (500), wherein the first polarizing layer (200) is positioned on a side of a light source (100), and is used for converting light received into linear polarizing light; the first phase retarding layer (300) is positioned on the side of the first polarizing layer (200) that is away from the light source (100), and is used for converting the linear polarizing light into oval polarizing light; the second phase retarding layer (400) is positioned on the side of the first phase retarding layer (300) that is away from the first polarizing layer (200), and is used for converting the oval polarizing light into linear polarizing light; the second polarizing layer (500) is positioned on the side of the second phase retarding layer (400) that is away from the first phase retarding layer (300), and is used for absorbing the linear polarizing light; and birefringence of the first phase retarding layer (300) and the second phase retarding layer (400) does not decrease as the wavelength of visible light increases. The display effect of a display is improved by using the phase retarding

### TECHNICAL FIELD

The disclosure refers to the field of display technology, and in particular to a phase retarding apparatus, a preparation method therefor, and a display device.

### BACKGROUND

With the increasing popularity of cell phones, tablet computers, car monitors and other terminal devices, lightweight, small Liquid Crystal Displays (LCDs) have emerged, of which IPS- and FFS-type LCD displays occupy a larger market with their better performance at viewing angles.

Currently, in IPS- and FFS-type LCD displays, compensation films, such as those formed by superimposing +A Plate and +C Plate of positively distributed liquid crystals, can be added to polarizers so as to improve the performance at side viewing angles. However, because of the poor characteristics of positively distributed liquid crystals after film formation, this compensation film structure cannot avoid the problem of dark-state light leakage caused by projection deviation of polarization axis of the polarizer at different wavebands, resulting in poor performance at side viewing angle of the display at wide wavebands.

### SUMMARY

The purpose of some embodiments of the disclosure is to provide a phase retarding apparatus, a preparation method therefor, and a display device, for solving the problem of poor performance at side viewing angle of the display at wide wavebands that exists in the prior art.

In order to solve the above-mentioned technical problem, embodiments of the disclosure are implemented as follows.

In a first aspect, the embodiments of the disclosure provide a phase retarding apparatus,
wherein the phase retarding apparatus comprises a first polarization layer, a first phase retardation layer, a second phase retardation layer and a second polarization layer;
the first polarization layer is located on the side toward a light source and is configured to convert received light into linear polarized light;
the first phase retardation layer is located on the side of the first polarization layer away from the light source and is configured to convert the linear polarized light to elliptical polarized light;
the second phase retardation layer is located on the side of the first phase retardation layer away from the first polarization layer and is configured to convert the elliptical polarized light to linear polarized light;
the second polarization layer is located on the side of the second phase retardation layer away from the first phase retardation layer and is configured to absorb the linear polarized light;
the birefringence of the first phase retardation layer and the second phase retardation layer does not decrease with increasing wavelength of visible light, at least one of the first phase retardation layer and the second phase retardation layer is a liquid crystal layer including negatively distributed liquid crystal, the distribution parameter of the negatively distributed liquid crystal satisfies a preset distribution range, and is determined by a target parameter of the negatively distributed liquid crystal in multiple different wave bands, and the target parameter comprises one or more of retardation amount and birefringence.

Optionally, the first phase retardation layer has refractive index satisfying N_{X}=N_{Y}<N_{Z}, wherein N_{X} is the refractive index of the first phase retardation layer in a direction of lagging phase axis, N_{Y} is the refractive index of the first phase retardation layer in a direction of overrunning phase axis, and N_{Z} is the refractive index of the first phase retardation layer in a thickness direction; the second phase retardation layer has refractive index satisfying M_{X}>M_{Y}=M_{Z}, wherein M_{X} is the refractive index of the second phase retardation layer in a direction of lagging phase axis, M_{Y} is the refractive index of the second phase retardation layer in a direction of overrunning phase axis, and M_{Z} is the refractive index of the second phase retardation layer in a thickness direction.

Optionally, the negatively distributed liquid crystal is negatively distributed Reactive Mesogen.

Optionally, the preset distribution range comprises a first subrange and a second subrange, wherein the first subrange is determined by the target parameters of the negatively distributed liquid crystal in a blue light waveband and in a green light waveband, while the second subrange is determined by the target parameters of the negatively distributed liquid crystal in an red light waveband and in the green light waveband.

Optionally, the first phase retardation layer and the second phase retardation layer are liquid crystal layers including the negatively distributed liquid crystal, and the phase retarding apparatus further comprises a first alignment layer and a second alignment layer, wherein the first alignment layer is configured to align the negatively distributed liquid crystal included in the first phase retardation layer based on a first pre-tilt angle, and the second alignment layer is configured to align the negatively distributed liquid crystal included in the second phase retardation layer based on a second pre-tilt angle,
the first alignment layer is located between the first polarization layer and the first phase retardation layer, and the second alignment layer is located between the first phase retardation layer and the second phase retardation layer; or
the first alignment layer is located between the first phase retardation layer and the second phase retardation layer, and the second alignment layer is located between the second phase retardation layer and the second polarization layer.

Optionally, the thickness of the first phase retardation layer is determined by the birefringence and the retardation amount of the first phase retardation layer in a preset waveband, and the thickness of the second phase retardation layer is determined by the birefringence and the retardation amount of the second phase retardation layer in a preset waveband.

Optionally, an optical axis of the second phase retardation layer is parallel to a transmission axis of the first polarization layer.

Optionally, one of the first phase retardation layer and the second phase retardation layer is a liquid crystal layer including the negatively distributed liquid crystal, and the other is a stretched film layer.

In a second aspect, embodiments of the present disclosure provide a display device comprising the phase retardation apparatus described in the first aspect above.

In a third aspect, embodiments of the present disclosure provide a preparation method for a phase retarding apparatus, and the method is applicable to a display device described in the second aspect. The method comprises:
obtaining the retardation amount of a first phase retardation layer; and
determining the retardation amount of a second phase retardation layer corresponding to the retardation amount of the first phase retardation layer, based on a preset correspondence between the retardation amount of the first phase retardation layer and the retardation amount of the second phase retardation layer, to reduce dark-state light leakage in a preset viewing angle caused by projection deviation of polarization axes of a first polarization layer and a second polarization layer under the action of the first phase retardation layer and the second phase retardation layer.

In a fourth aspect, embodiments of the present disclosure provide an electronic device comprising a processor, a memory and a computer program stored on the memory and runnable on the processor, wherein the computer program when executed by the processor implements the steps of the preparation method for the phase retarding apparatus provided in the above-mentioned embodiments.

In a fifth aspect, embodiments of the present disclosure provide a computer-readable storage medium, characterized in that a computer program is stored on the computer-readable storage medium, and the computer program when executed by a processor implements the steps of the preparation method for the phase retarding apparatus provided in the above-mentioned embodiments.

From the technical solutions provided by the above-mentioned embodiments of this disclosure, it can be seen that the embodiments of the present disclosure provide a phase retarding apparatus and a preparation method therefor, a display device. The phase retarding apparatus comprises a first polarization layer, a first phase retardation layer, a second phase retardation layer and a second polarization layer, wherein the first polarization layer is located on the side toward a light source for converting received light into linear polarized light, the first phase retardation layer is located on the side of the first polarization layer away from the light source for converting the linear polarized light into elliptical polarized light, the second phase retardation layer is located on the side of the first phase retardation layer away from the first polarization layer for converting the elliptical polarized light into linear polarized light, and the second polarization layer is located on the side of the second phase retardation layer away from the first phase retardation layer for absorbing the linear polarized light. The birefringence of the first phase retardation layer and the second phase retardation layer does not decrease with increasing wavelength of visible light. At least one of the first phase retardation layer and the second phase retardation layer comprises a liquid crystal layer including negatively distributed liquid crystal. The distribution parameter of the negatively distributed liquid crystal satisfies a preset distribution range, and is determined by a target parameter of the negatively distributed liquid crystal at a plurality of different wavebands. The target parameter comprises one or more of the retardation amount and the birefringence. In this way, since the birefringence of the first phase retardation layer and the second phase retardation layer in this phase retarding apparatus does not decrease with increasing wavelength of visible light, the problem of dark-state light leakage in a preset viewing angle caused by the projection deviation of the polarization axes of the first polarization layer and the second polarization layer may be avoided at different wavebands, i.e., the displaying effect of the display using this phase retarding apparatus may be improved in the preset viewing angle at wide wavebands.

### BRIEF DESCRIPTION OF DRAWINGS

In order to illustrate the technical solutions of the embodiments of the disclosure or in the prior art clearly, the following is a brief description of the drawings necessary to describe the embodiments or prior art. It is obvious that the drawings as described in the following are only some of the embodiments of the disclosure, and other drawings can be obtained from these drawings without creative labor for those of ordinary skill in the art.

FIG. 1 is a structural schematic diagram I of a phase retarding apparatus provided in an embodiment of the disclosure.

FIGS. 2(a) to 2(b) are schematic diagrams of a phase retarding apparatus provided in an embodiment of the disclosure.

FIGS. 3(a) to 3(b) are schematic diagrams of effect I of a phase retarding apparatus provided in an embodiment of the disclosure.

FIGS. 4(a) to 4(b) are schematic diagrams of effect II of a phase retarding apparatus provided in an embodiment of the disclosure.

FIG. 5 is a schematic diagram of effect III of a phase retarding apparatus provided in an embodiment of the disclosure.

FIGS. 6(a) to 6(b) are structural schematic diagrams II of a phase retarding apparatus provided in an embodiment of the disclosure.

FIG. 7 is a structural schematic diagram of a display device provided in an embodiment of the disclosure.

FIG. 8 is a schematic flowchart of a phase retarding apparatus provided in an embodiment of the disclosure.

FIG. 9 is a structural schematic diagram of an electronic device of the present disclosure.

### DETAILED DESCRIPTION OF EMBODIMENTS

The disclosure provides a phase retarding apparatus, a preparation method therefor, and a display device.

In order to enable those skilled in the art to better understand the technical solutions in this disclosure, the technical solutions of embodiments in this disclosure will be clearly and completely described below in conjunction with drawings of the embodiments therein. Obviously, the embodiments to be described are only a part but not all of the embodiments of this disclosure. Based on the embodiments in this disclosure, all other embodiments obtained by a person of ordinary skill in the art without paying creative effort shall fall within the protection scope of this disclosure.

### Embodiment I

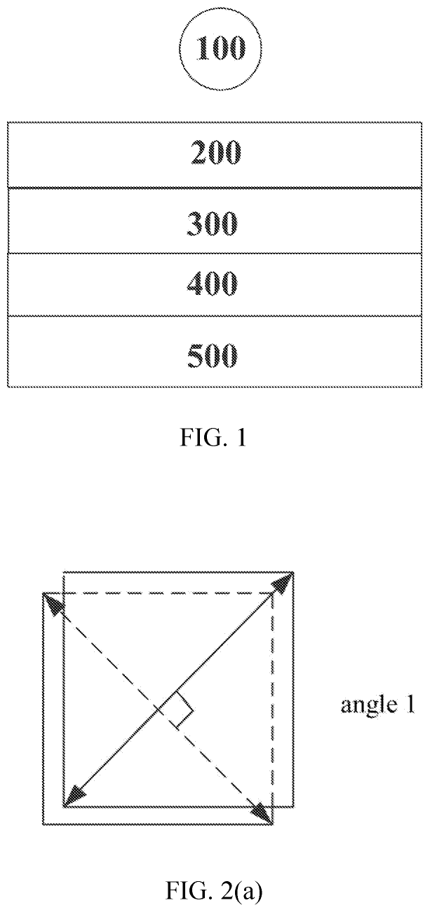

FIG. 1 is a structural schematic diagram I of a phase retarding apparatus provided in an embodiment of the disclosure. The phase retarding apparatus comprises a polarization layer 200, a first phase retardation layer 300, a second phase retardation layer 400, and a second polarization layer 500, wherein:
the first polarization layer 200 may be located on the side toward a light source 100 and is configured to convert received light into linear polarized light. The light source 100 may be any light source 100 capable of emitting natural light, and the first polarization layer 200 may include any device capable of converting the natural light emitted by the light source 100 into linear polarized light, such as a linear polaroid and a line grid polarizer.

The first phase retardation layer 300 may be located on the side of the first polarization layer 200 away from the light source 100 and is configured to convert the linear polarized light to elliptical polarized light.

The second phase retardation layer 400 may be located on the side of the first phase retardation layer 300 away from the first polarization layer 200 and is configured to convert the elliptical polarized light to linear polarized light.

The second polarization layer 500 may be located on the side of the second phase retardation layer 400 away from the first phase retardation layer 300 and is configured to absorb linear polarized light.

The birefringence of the first phase retardation layer 300 and the second phase retardation layer 400 does not decrease with increasing wavelength of visible light. At least one of the first phase retardation layer 300 and the second phase retardation layer 400 is a liquid crystal layer including negatively distributed liquid crystal. The distribution parameter of the negatively distributed liquid crystal satisfies a preset distribution range. The distribution parameter is determined by a target parameter of the negatively distributed liquid crystal in multiple different wave bands, the target parameter comprising one or more of the retardation amount and the birefringence.

Herein, the retardation amount and the birefringence difference (i.e., birefringence difference between fast and slow axes of the negatively distributed liquid crystal) of the negatively distributed liquid crystal included in the phase retardation layer(s) (i.e., the first phase retardation layer 300 and/or the second phase retardation layer 400) may have a positive relationship, e.g., the retardation amount of the negatively distributed liquid crystal may be a product of the birefringence difference and a thickness of the phase retardation layer, so that it is possible to determine the distribution parameter based on the retardation amount of the phase retardation layer at different wave bands, and it is also possible to determine the distribution parameter based on the birefringence difference of the phase retardation layer at different wave bands.

The above-mentioned method of determining the distribution parameter of the negatively distributed liquid crystal is an optional and achievable method, and there may be a variety of different determination methods in practical scenarios, which are not specifically limited by the embodiments of the present disclosure.

In addition, both the first phase retardation layer 300 and the second phase retardation layer 400 may be liquid crystal layers including negatively distributed liquid crystal, or, either the first phase retardation layer 300 or the second phase retardation layer 400 may be a liquid crystal layer including negatively distributed liquid crystal, and the other layer may be any phase retardation layer capable of achieving the birefringence that does not decrease with increasing wavelength of visible light.

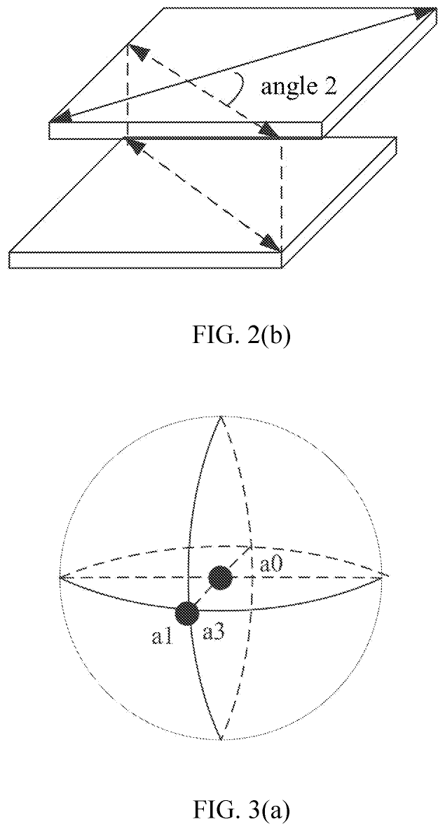

As shown in FIG. 2(a), in the case where the phase retarding apparatus does not contain the first phase retardation layer 300 and the second phase retardation layer 400, an angle between the optical axes of the first polarization layer 200 and the second polarization layer 500 at a front viewing angle (i.e., the angle 1) is 90°, so that the second polarization layer 500 may better absorb the light converted by the first polarization layer 200 and avoid light leakage, while as shown in FIG. 2(b), at a side viewing angle (such as 45 degrees and 60 degrees), projections of the polarization axes of the first polarization layer 200 and the second polarization layer 500 have a deviation (i.e., the angle 2 is not equal to 90 degrees), and the deviation of the projections of the polarization axes lead to dark-state light leakage at the side viewing angle.

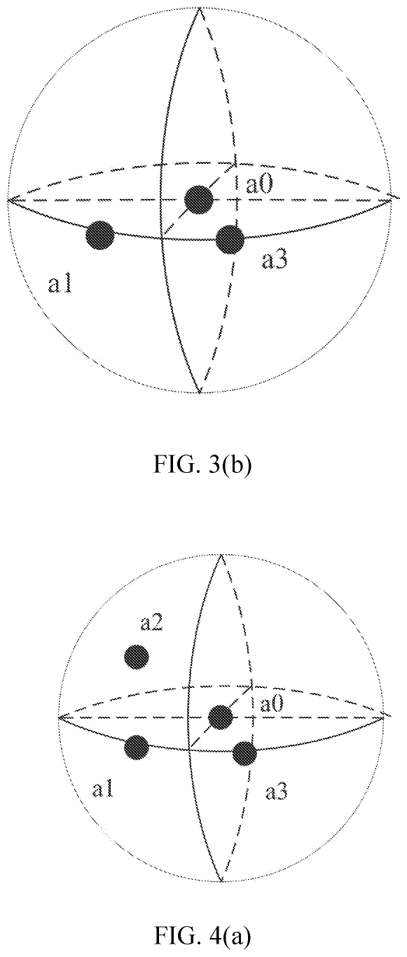

Accordingly, under the definition of Poincare sphere, as shown in FIG. 3(a), in the case that the first polarization layer 200 and the second polarization layer 500 are at a front viewing angle, when the light emitted from the light source 100 passes through the first polarization layer 200, it is converted into linear polarized light, wherein the light emitted from the light source 100 is natural light, i.e., the optical state of this light falls at a0 on the Poincare sphere, and the polarization state of the linear polarized light from the first polarization layer 200 falls at a1 on the Poincare sphere. The polarization state of the linear polarized light which could be absorbed by the second polarization layer 500 falls at a3 on the Poincare sphere coinciding with a1. Therefore, the linear polarized light from the first polarization layer 200 is absorbed by the second polarization layer 500. In FIG. 3(b). In the case that the first polarization layer 200 and the second polarization layer 500 are at a side viewing angle, the natural light from the light source 100 is converted into linear polarized light after passing through the first polarization layer 200, and the polarization state of the linear polarized light falls at a1 on the Poincare sphere that does not coincide with a3 (wherein a3 is the point on the Poincare sphere at which the polarization state of the linear polarized light that could be absorbed by the second polarization layer 500 falls), that is, the linear polarized light from the first polarization layer 200 cannot be absorbed by the second polarization layer 500, so the problem of dark-state light leakage arises.

Therefore, the first phase retardation layer 300 and the second phase retardation layer 400 may be added to the phase retarding apparatus so that the linear polarized light from the first polarization layer 200 may be absorbed by the second polarization layer 500 after an optical path difference between the first phase retardation layer 300 and the second phase retardation layer 400 in the case that the first polarization layer 200 and the second polarization layer 500 are at a side viewing angle, i.e., it is possible to make a1 and a3 in FIG. 3(b) coincident.

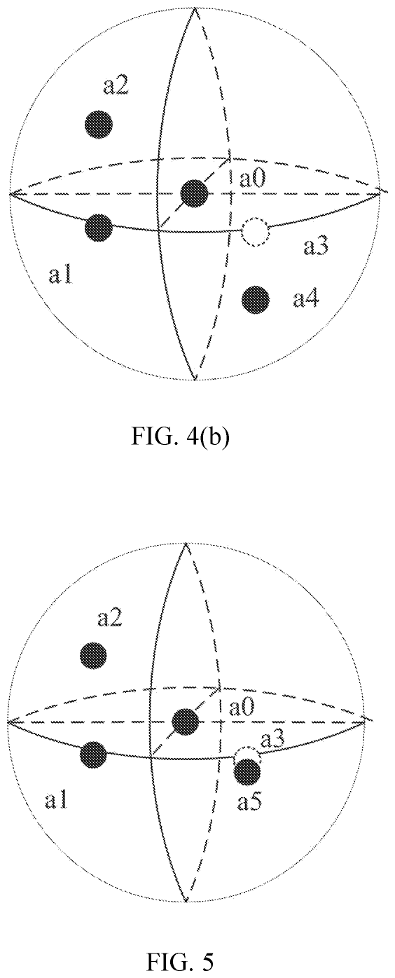

Assuming that the birefringence of the first phase retardation layer 300 and the second phase retardation layer 400 decreases as the wavelength of visible light increases, in the Poincare sphere shown in FIG. 4(a), at the side viewing angle (e.g., 45 degrees, 60 degrees, etc.) and in the green light waveband (e.g., 550 nm waveband), after the light emitted from the light source 100 (i.e., at this moment, the optical state of the light falls at a0 on the Poincare sphere) passes through the first polarization layer 200, it is converted to linear polarized light (i.e., at this moment, the polarization state of linear polarized light falls at a1 on the equator of the Poincare sphere), and the linear polarized light is converted to elliptical polarized light by the first phase retardation layer 300 (i.e., at this moment, the polarization state of elliptical polarized light falls at a2 on an upper hemisphere of the Poincare sphere). The elliptical polarized light is converted to linear polarized light by the second phase retardation layer 400 (i.e., at this moment, the polarization state of linear polarized light falls at a3 on the equator of the Poincare sphere in the same optical state as the light that could be absorbed by the second polarization layer 500). In this way, the second polarization layer 500 may absorb the linear polarized light obtained by the convert of the second phase retardation layer 400 through the compensation of the first phase retardation layer 300 and the second phase retardation layer 400 in the green light waveband, which shows that the performance thereof at a side viewing angle is better in the green light waveband. It may avoid the problem of dark-state light leakage caused by the deviation of the projections of the polarization axes of the first polarization layer 200 and the second polarization layer 500 at the side viewing angle.

However, as shown in FIG. 4(b), in the blue light waveband (e.g., 450 nm waveband), the elliptical polarized light is still elliptical polarized light after being converted by the second phase retardation layer 500, i.e., the optical state of the light reaches a4 on the sphere of the lower hemisphere of the Poincare sphere from a2, and there is a certain distance between a4 and a3 (i.e., the optical state a4 after the first polarization layer 200, the first phase retardation layer 300 and the second phase retardation layer 400, does not coincide with the optical state a3 that may be absorbed by the second polarization layer 500) so that the second polarization layer 500 cannot absorb the linear polarized light passing through the first polarization layer 200 completely at the side viewing angle, and thus the dark-state light leakage will occur at the side viewing angle in the blue light waveband. Therefore if the birefringence of the first phase retardation layer 300 and the second phase retardation layer 400 decreases with wavelength of visible light increases, there is a problem of poor performance at the side viewing angle at a wide waveband.

Instead, the birefringence of the first phase retardation layer 300 and the second phase retardation layer 400 used in this embodiment of the present disclosure does not decrease with the increase of wavelength of visible light. As shown in FIG. 5, the linear polarized light from the first polarization layer 200 in the blue light waveband (e.g., 450 nm waveband) may be compensated by the first phase retardation layer 300 and the second bit phase retardation layer 400, which may enable the optical state of the light to reach from a2 to a5 near the equator in the spherical surface of the lower hemisphere of the Poincare sphere, and the distance between a5 and the optical state a3 which may be absorbed by the second polarization layer 500, is smaller compared to the distance between a4 and a3 in FIG. 4(b). Obviously, the performance at side viewing angles at different wavelengths of the phase retarding apparatus may be improved by the phase retarding apparatus at wide wavebands at side viewing angle when the birefringence of the first phase retardation layer 300 and the second phase retardation layer 400 does not decrease with the increase of wavelength of visible light.

An embodiment of the present disclosure provides a phase retarding apparatus, and the phase retarding apparatus comprises a first polarization layer, a first phase retardation layer, a second phase retardation layer and a second polarization layer, wherein the first polarization layer is located on the side toward a light source for converting received light into linear polarized light, the first phase retardation layer is located on the side of the first polarization layer away from the light source for converting the linear polarized light into elliptical polarized light, the second phase retardation layer is located on the side of the first phase retardation layer away from the first polarization layer for converting the elliptical polarized light into linear polarized light, and the second polarization layer is located on the side of the second phase retardation layer away from the first phase retardation layer for absorbing the linear polarized light. The birefringence of the first phase retardation layer and the second phase retardation layer does not decrease with increasing wavelength of visible light. At least one of the first phase retardation layer and the second phase retardation layer is a liquid crystal layer including negatively distributed liquid crystal. The distribution parameter of the negatively distributed liquid crystal satisfies a preset distribution range, and is determined by a target parameter of the negatively distributed liquid crystal at a plurality of different wavebands. The target parameter comprises one or more of the retardation amount and the birefringence. In this way, since the birefringence of the first phase retardation layer and the second phase retardation layer in this phase retarding apparatus does not decrease with increasing wavelength of visible light, the problem of dark-state light leakage in a preset viewing angle caused by the projection deviation of the polarization axes of the first polarization layer and the second polarization layer may be avoided at different wavebands, i.e., the displaying effect of the display using this phase retardation apparatus may be improved at the preset viewing angle at wide wavebands.

### Embodiment II

An embodiment of the present disclosure provides yet another phase retarding apparatus. The phase retarding apparatus contains all the functional units of the phase retarding apparatus of Embodiment I described above, and improves it on the basis thereof as follows.

The first phase retardation layer 300 has refractive index satisfying N_{X}=N_{Y}<N_{Z}, wherein N_{X} is the refractive index of the first phase retardation layer 300 in a direction of lagging phase axis, N_{Y} is the refractive index of the first phase retardation layer 300 in a direction of overrunning phase axis, and N_{Z} is the refractive index of the first phase retardation layer 300 in a thickness direction.

The second phase retardation layer 400 has refractive index satisfying M_{X}>M_{Y}=M_{Z}, wherein M_{X} is the refractive index of the second phase retardation layer 400 in a direction of lagging phase axis, M_{Y} is the refractive index of the second phase retardation layer 400 in a direction of overrunning phase axis, and M_{Z} is the refractive index of the second phase retardation layer 400 in a thickness direction.

The negatively distributed liquid crystal may be negatively distributed Reactive Mesogen (RM), and light alignment molecules may be doped in the RM to simplify the process of alignment and improve production efficiency. For example, a mixture of RM and alignment molecules may be coated on a substrate (e.g., a flexible super wave substrate) and cured with polarized UV light to complete the alignment and fabrication of the first phase retardation layer 300 and/or the second phase retardation layer 400.

The preset distribution range may comprise a first subrange and a second subrange, wherein the first subrange may be determined by the target parameters of the negatively distributed liquid crystal in the blue light waveband and in the green light waveband, while the second subrange is determined by the target parameters of the negatively distributed liquid crystal in the red light waveband and in the green light waveband.

For example, the first subrange may be determined from the ratio between the retardation amount of the negatively distributed liquid crystal in the blue light waveband and the retardation amount of the negatively distributed liquid crystal in the green light waveband, while the second subrange may be determined from the ratio between the retardation amount of the negatively distributed liquid crystal in the red light waveband and the retardation amount of the negatively distributed liquid crystal in the green light waveband.

The distribution parameters of the negatively distributed liquid crystal need to meet the preset distribution range, for example, the first subrange may be less than 0.9 and more than 0.7, the second subrange may be not less than 0.95 and less than 1.2, the ratio between the retardation amount of the negatively distributed liquid crystal in the blue light waveband and the retardation amount of the negatively distributed liquid crystal in the green light waveband may be 0.9, and the ratio between the retardation amount of the negatively distributed liquid crystal in the red light waveband and the retardation amount of the negatively distributed liquid crystal in the green light waveband may be 1, i.e., satisfying the first subrange and the second subrange mentioned above, respectively.

In addition, the distribution parameters of the negatively distributed liquid crystal may also be determined based on the birefringence of the negatively distributed liquid crystal in the red light waveband, in the green light waveband, and in the blue light waveband, for instance, the distribution parameters of the negatively distributed liquid crystal may comprises: a first distribution parameter satisfying the first subrange, which may be the ratio between the birefringence difference of the negatively distributed liquid crystal in the blue light waveband and the birefringence difference of the negatively distributed liquid crystal in the green light waveband; and a second distribution parameter satisfying the second subrange, which may be the ratio between the birefringence difference of the negatively distributed liquid crystal in the red light waveband and the birefringence difference of the negatively distributed liquid crystal in the green light waveband.

The above-mentioned method of determining the distribution parameter of the negatively distributed liquid crystal is an optional and achievable method, and there may be a variety of different determination methods in practical scenarios, which may vary according to the practical scenario, and are not specifically limited by the embodiments of the present disclosure.

The first phase retardation layer 300 and the second phase retardation layer 400 may be liquid crystal layers including negatively distributed liquid crystal, and the phase retarding apparatus may also comprise a first alignment layer 600 and a second alignment layer 700, wherein the first alignment layer 600 may be used to align the negatively distributed liquid crystal included in the first phase retardation layer 300 based on a first pre-tilt angle, and the second alignment layer 700 may be used to align the negatively distributed liquid crystal included in the second phase retardation layer 400 based on a second pre-tilt angle.

Herein, each of the first phase retardation layer 300 and the second phase retardation layer 400 may be a liquid crystal layer containing negatively distributed Reactive Mesogen, and each of the first alignment layer 600 and the second alignment layer 700 may be a liquid crystal alignment film constituted by a industrial macromolecule Liquid Crystal Polymer (LCP) film. The first pre-tilt angle may be any pre-tilt angle in the first tilt angle range (such as 0°˜10° and 0°˜2°), for instance, the first pre-tilt angle may be 2°, while the second pre-tilt angle may be any pre-tilt angle in the second tilt angle range (such as 80°˜90° and 88°˜90°).

During alignment, the liquid crystal alignment film is coated and dried, then the alignment may be performed with polarized UV light, and the direction of alignment may be that of the optical axis of the second phase retardation layer 400. Then, the RM is coated, and after that, the liquid crystal is aligned in the direction of preset alignment. Therein, the alignment process of the alignment layer (comprising the first alignment layer 600 and the second alignment layer 700) may be an optical alignment process, and in addition, there may further be a variety of different alignment processes, such as frictional alignment process. The alignment process may be selected according to the different practical scenarios, and the embodiments of the present disclosure do not make specific limitations thereto.

After alignment, the liquid crystal molecules contained in the second phase retardation layer 400 may be arranged parallel to a surface of a base film, and the optical axis of the liquid crystal molecules contained in the first phase retardation layer 300 may be perpendicular to the surface of the base film, i.e., it is achieved that the refractive index of the second phase retardation layer 400 satisfies M_{X}>M_{Y}=M_{Z}, and the refractive index of the first phase retardation layer 300 satisfies N_{X}=N_{Y}<N_{Z}.

After completing the alignment process, UV-light curing is required. The wavelength of the curing light may be UV-A, and nitrogen may be used in the curing process for protection. In addition, there may further be a variety of specific curing processes, which are not specifically limited by the embodiments of the present disclosure.

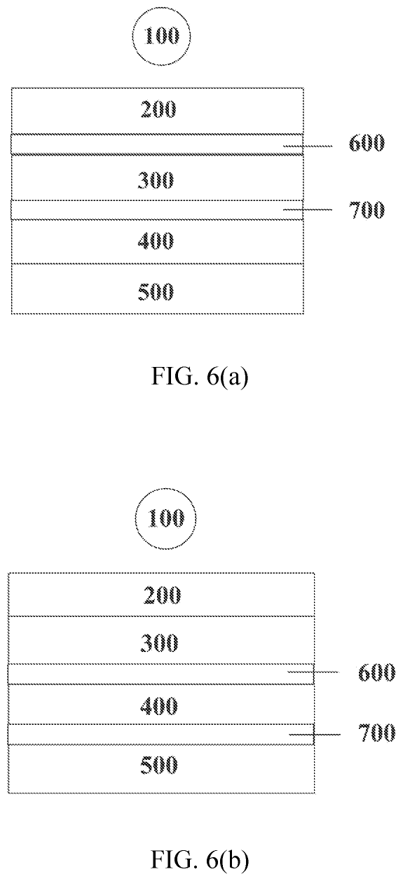

As shown in FIG. 6(a), the first alignment layer 600 may be located between the first polarization layer 200 and the first phase retardation layer 300, and the second alignment layer 700 may be located between the first phase retardation layer 300 and the second phase retardation layer 400.

Alternatively, as shown in FIG. 6(b), the first alignment layer 600 may be located between the first phase retardation layer 300 and the second phase retardation layer 400, and the second alignment layer 700 may be located between the second phase retardation layer 400 and the second polarization layer 500.

The thickness of the first phase retardation layer 300 may be determined by the birefringence and retardation amount of the first phase retardation layer 300 in a preset waveband, and the thickness of the second phase retardation layer 400 may be determined by the birefringence and retardation amount of the second phase retardation layer 400 in a preset waveband.

For example, the thickness of a phase retardation layer (the first phase retardation layer 300 or the second phase retardation layer 400) may be a ratio of the retardation amount of the phase retardation layer to the birefringence difference of the negatively distributed liquid crystal contained in the phase retardation layer (i.e., the birefringence difference between the fast and slow axes of the negatively distributed liquid crystal), wherein the thickness of the phase retardation layer may vary depending on the birefringence difference between the fast and slow axes of the negatively distributed liquid crystal. The birefringence difference between the fast and slow axes of the negatively distributed liquid crystal may lie within a preset range of refractive index difference, which for example, may be not less than 0.01 and not more than 0.3.

Taking the second phase retardation layer 400 as an example, the retardation amount of the second phase retardation layer in the green light waveband (e.g., 550 nm waveband) may be any retardation amount in a first retardation amount range (e.g., 50 nm˜170 nm, 120 nm˜150 nm, etc.), and the corresponding thickness of the second phase retardation layer 400 may be the ratio of the retardation amount of the second phase retardation layer 400 to the birefringence difference of the negatively distributed liquid crystal contained in the second phase retardation layer 400.

Taking the first phase retardation layer 300 as an example, the retardation amount of the first phase retardation layer in the green light waveband (e.g., 550 nm waveband) may be any retardation amount in a second retardation amount range (e.g., 60 nm˜120 nm, 80 nm˜110 nm, etc.), and the corresponding thickness of the first phase retardation layer 300 may be the ratio of the retardation amount of the first phase retardation layer 300 to the birefringence difference of the negatively distributed liquid crystal contained in the first phase retardation layer 300.

The optical axis of the second phase retardation layer 400 may be parallel to the transmission axis of the first polarization layer 200, and preferably, the slow axis of the second phase retardation layer 400 may be parallel to the transmission axis of the first polarization layer 200.

One of the first phase retardation layer 300 and the second phase retardation layer 400 may be a liquid crystal layer including negatively distributed liquid crystal, and the other is a stretched film layer, wherein, the stretched film layer may be composed of Polycarbonate board (PC) material.

An embodiment of the present disclosure provides a phase retarding apparatus, and the phase retarding apparatus comprises a first polarization layer, a first phase retardation layer, a second phase retardation layer and a second polarization layer, wherein the first polarization layer is located on the side toward a light source for converting received light into linear polarized light, the first phase retardation layer is located on the side of the first polarization layer away from the light source for converting the linear polarized light into elliptical polarized light, the second phase retardation layer is located on the side of the first phase retardation layer away from the first polarization layer for converting the elliptical polarized light into linear polarized light, and the second polarization layer is located on the side of the second phase retardation layer away from the first phase retardation layer for absorbing the linear polarized light. The birefringence of the first phase retardation layer and the second phase retardation layer does not decrease with increasing wavelength of visible light. At least one of the first phase retardation layer and the second phase retardation layer is a liquid crystal layer including negatively distributed liquid crystal. The distribution parameter of the negatively distributed liquid crystal satisfies a preset distribution range, and is determined by a target parameter of the negatively distributed liquid crystal at a plurality of different wavebands. The target parameter comprises one or more of the retardation amount and the birefringence therein. In this way, since the birefringence of the first phase retardation layer and the second phase retardation layer in this phase retarding apparatus does not decrease with increasing wavelength of visible light, the problem of dark-state light leakage in a preset viewing angle caused by the projection deviation of the polarization axes of the first polarization layer and the second polarization layer may be avoided at different wavebands, i.e., the displaying effect of the display using this phase retardation apparatus may be improved in the preset viewing angle at wide wavebands.

### Embodiment III

Embodiments of the present disclosure provide a display device that may comprise at least one of the phase retardation apparatuses in Embodiments I and II above, wherein
the first polarization layer 200 may be located on the side toward a light source 100 and is configured to convert received light into linear polarized light.

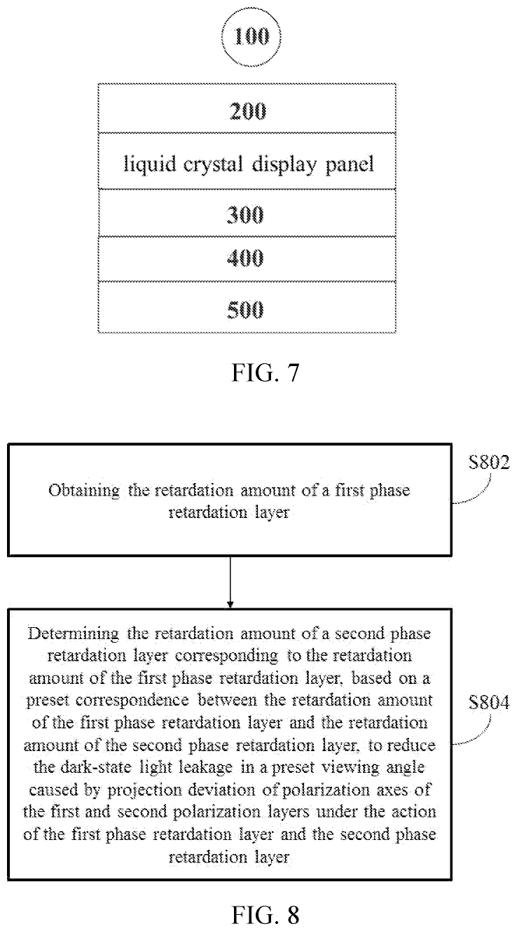

As shown in FIG. 7, between the first polarization layer 200 and the first phase retardation layer 300, a liquid crystal display panel may be configured, and the liquid crystal display panel may be an In-Plane Switching (IPS) liquid crystal display panel, a Fringe Field Switching (FFS) liquid crystal display panel, or the like.

The first phase retardation layer 300 may be configured to convert linear polarized light to elliptical polarized light.

The second phase retardation layer 400 may be located on the side of the first phase retardation layer 300 away from the first polarization layer and is configured to convert the elliptical polarized light to linear polarized light.

The second polarization layer 500 may be located on the side of the second phase retardation layer 400 away from the first phase retardation layer 300 and is configured to absorb the linear polarized light.

The birefringence of the first phase retardation layer 300 and the second phase retardation layer 400 may not decrease with increasing wavelength of visible light. At least one of the first phase retardation layer 300 and the second phase retardation layer 400 is a liquid crystal layer including negatively distributed liquid crystal. The distribution parameter of the negatively distributed liquid crystal satisfies a preset distribution range, and is determined by a target parameter of the negatively distributed liquid crystal in multiple different wave bands. The target parameter comprises one or more of the retardation amount, and the birefringence.

An embodiment of the present disclosure provides a display device, and the display device comprises a phase retarding apparatus, the phase retarding apparatus comprises a first polarization layer, a first phase retardation layer, a second phase retardation layer and a second polarization layer, wherein the first polarization layer is located on the side toward a light source for converting received light into linear polarized light, the first phase retardation layer is located on the side of the first polarization layer away from the light source for converting the linear polarized light into elliptical polarized light, the second phase retardation layer is located on the side of the first phase retardation layer away from the first polarization layer for converting the elliptical polarized light into linear polarized light, and the second polarization layer is located on the side of the second phase retardation layer away from the first phase retardation layer for absorbing the linear polarized light. The birefringence of the first phase retardation layer and the second phase retardation layer does not decrease with increasing wavelength of visible light. At least one of the first phase retardation layer and the second phase retardation layer is a liquid crystal layer including negatively distributed liquid crystal. The distribution parameter of the negatively distributed liquid crystal satisfies a preset distribution range and is determined by a target parameter of the negatively distributed liquid crystal at a plurality of different wavebands. The target parameter comprises one or more of the retardation amount and the birefringence. In this way, since the birefringence of the first phase retardation layer and the second phase retardation layer in this phase retarding apparatus does not decrease with increasing wavelength of visible light, the problem of dark-state light leakage in a preset viewing angle caused by the projection deviation of the polarization axes of the first polarization layer and the second polarization layer may be avoided at different wavebands, i.e., the display effect of the display using this phase retarding apparatus may be improved in the preset viewing angle at wide wavebands.

### Embodiment IV

Hereinabove, a phase retarding apparatus is provided by embodiments of the present disclosure. Based on the functions and composition structure of the phase retarding apparatus, embodiments of the present disclosure further provide a preparation method for a phase retarding apparatus, wherein the method may be performed mainly by an electronic device, and the electronic device may be used for preparing the phase retarding apparatus as described in the above-mentioned Embodiments I and II. As shown in FIG. 8, the method may specifically comprise the following steps.

S802: Obtaining a retardation amount of a first phase retardation layer.

S804: Determining the retardation amount of a second phase retardation layer corresponding to the retardation amount of the first phase retardation layer, based on the preset correspondence between the retardation amount of the first phase retardation layer and the retardation amount of the second phase retardation layer, so as to reduce the dark-state light leakage in a preset viewing angle caused by projection deviation of polarization axes of the first and second polarization layers under the action of the first phase retardation layer and the second phase retardation layer.

In an implementation, the preset correspondence between the retardation amount of the first phase retardation layer and the retardation amount of the second phase retardation layer may be determined based on the historical retardation amount of the first phase retardation layer and the historical retardation amount of the second phase retardation layer. The retardation amount of the second phase retardation layer corresponding to the retardation amount of the first phase retardation layer may be determined based on the determined preset correspondence.

Therein, various methods may be applied for determining the retardation amount of the second phase retardation layer, and it is also possible to train a preset machine learning algorithm based on historical data (i.e., the historical retardation amount of the first phase retardation layer, and the historical retardation amount of the second phase retardation layer), and determine the retardation amount of the second phase retardation layer based on the trained machine learning algorithm and the obtained retardation amount of the first phase retardation layer. The methods for determining the retardation amount of the second phase retardation layer may vary according to the practical scenario, and the embodiments of the present disclosure do not limit this specifically.

An embodiment of the present disclosure provides a preparation method for a phase retarding apparatus, and the phase retarding apparatus comprises a first polarization layer, a first phase retardation layer, a second phase retardation layer and a second polarization layer, wherein the first polarization layer is located on the side toward a light source for converting received light into linear polarized light, the first phase retardation layer is located on the side of the first polarization layer away from the light source for converting the linear polarized light into elliptical polarized light, the second phase retardation layer is located on the side of the first phase retardation layer away from the first polarization layer for converting the elliptical polarized light into linear polarized light, and the second polarization layer is located on the side of the second phase retardation layer away from the first phase retardation layer for absorbing the linear polarized light. The birefringence of the first phase retardation layer and the second phase retardation layer does not decrease with increasing wavelength of visible light. At least one of the first phase retardation layer and the second phase retardation layer comprises a liquid crystal layer including negatively distributed liquid crystal. The distribution parameter of the negatively distributed liquid crystal satisfies a preset distribution range, and is determined by a target parameter of the negatively distributed liquid crystal at a plurality of different wavebands. The target parameter comprises one or more of the retardation amount and the birefringence. In this way, since the birefringence of the first phase retardation layer and the second phase retardation layer in this phase retarding apparatus does not decrease with increasing wavelength of visible light, the problem of dark-state light leakage in a preset viewing angle caused by the projection deviation of the polarization axes of the first polarization layer and the second polarization layer may be avoided at different wavebands, i.e., the displaying effect of the display using this phase retarding apparatus may be improved in the preset viewing angle at wide wavebands.

### Embodiment V

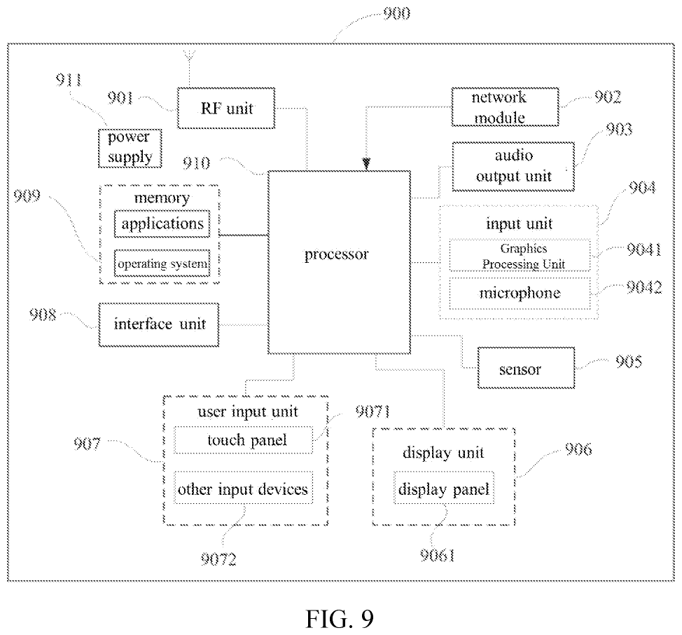

FIG. 9 is a schematic diagram of hardware structure of an electronic device that implements Embodiments IV and V of the present disclosure.

The electronic device 900 comprises, but is not limited to, an RF unit 901, a network module 902, an audio output unit 903, an input unit 904, a sensor 905, a display unit 906, a user input unit 907, an interface unit 908, a memory 909, a processor 910, and a power supply 911, etc. It will be understood by those skilled in the art that the structure of the electronic device illustrated in FIG. 9 does not constitute a limitation of the electronic device, and that the electronic device may comprise more or fewer components than the illustrated, or combine certain components, or arrange the components differently. In embodiments of the present disclosure, the electronic device includes, but is not limited to, a cell phone, a tablet computer, a laptop computer, a handheld computer, a vehicle terminal, a wearable device, a pedometer, or the like.

Therein, the processor 910 is configured for obtaining a retardation amount of a first phase retardation layer.

In addition the processor 910 is further configured for determining the retardation amount of a second phase retardation layer corresponding to the retardation amount of the first phase retardation layer, based on the preset correspondence between the retardation amount of the first phase retardation layer and the retardation amount of the second phase retardation layer, so as to reduce the dark-state light leakage in a preset viewing angle caused by projection deviation of polarization axes of the first and second polarization layers under the action of the first phase retardation layer and the second phase retardation layer.

An embodiment of the present disclosure provides an electronic device, which is configured for preparing a phase retarding apparatus. the phase retarding apparatus comprises a first polarization layer, a first phase retardation layer, a second phase retardation layer and a second polarization layer, wherein the first polarization layer is located on the side toward a light source for converting received light into linear polarized light, the first phase retardation layer is located on the side of the first polarization layer away from the light source for converting the linear polarized light into elliptical polarized light, the second phase retardation layer is located on the side of the first phase retardation layer away from the first polarization layer for converting the elliptical polarized light into linear polarized light, the second polarization layer is located on the side of the second phase retardation layer away from the first phase retardation layer for absorbing the linear polarized light. The birefringence of the first phase retardation layer and the second phase retardation layer does not decrease with increasing wavelength of visible light. At least one of the first phase retardation layer and the second phase retardation layer is a liquid crystal layer including negatively distributed liquid crystal. The distribution parameter of the negatively distributed liquid crystal satisfies a preset distribution range, and is determined by a target parameter of the negatively distributed liquid crystal at a plurality of different wavebands. The target parameter comprises one or more of the retardation amount and the birefringence. In this way, since the birefringence of the first phase retardation layer and the second phase retardation layer in this phase retarding apparatus does not decrease with increasing wavelength of visible light, the problem of dark-state light leakage in a preset viewing angle caused by the projection deviation of the polarization axes of the first polarization layer and the second polarization layer may be avoided at different wavebands, i.e., the display effect of the display using this phase retarding apparatus may be improved in the preset viewing angle at wide wavebands.

It should be understood that, in the embodiments of the present disclosure, the RF unit 901 may be configured for reception and transmission of signals during sending and receiving messages or calls. Specifically, downlink data from a base station is received and then provided to the processor 910 for processing. In addition, uplink data is sent to the base station. Typically, the RF unit 901 comprises, but is not limited to, an antenna, at least one amplifier, a transceiver, a coupler, a low-noise amplifier, a duplexer, etc. In addition, the RF unit 901 may also communicate with networks and other devices through wireless communication systems.

The electronic device provides a user with wireless broadband Internet access through the network module 902, such as helping users send and receive E-mails, browse webpages and access streaming media.

The audio output unit 903 may convert audio data received by the RF unit 901 or the network module 902 or stored in the memory 909 into audio signals and output them as sound. Moreover, the audio output unit 903 may further provide audio output associated with a specific function performed by the electronic device 900 (e.g., call signal reception sound, message reception sound, etc.). The audio output unit 903 comprises a speaker, a buzzer, and a receiver, etc.

The input unit 904 is configured to receive audio or video signals. The input unit 904 may comprise a Graphics Processing Unit (GPU) 9041 and a microphone 9042, and the Graphics Processing Unit 9041 processes image data of static pictures or videos obtained by an image capture device (e.g., a camera) in a video capture mode or an image capture mode. The image frames, after being processed, may be displayed on the display unit 906. The image frames processed by the Graphics Processing Unit 9041 may be stored in the memory 909 (or other storage media) or sent via the RF unit 901 or the network module 902. The microphone 9042 may receive sound and process it into audio data. The audio data, after being processed, may be converted, under a telephone talking mode, to a format of output that may be sent to a mobile base station via the RF unit 901.

The electronic device 900 further comprises at least one sensor 905, such as a light sensor, a motion sensor, and other sensors. Specifically, the light sensor comprises an ambient light sensor and a proximity sensor, wherein the ambient light sensor may adjust brightness of a display panel 9061 based on brightness of ambient light, and the proximity sensor may turn off the display panel 9061 and/or backlight when the electronic device 900 is moved to the ear. As a type of motion sensor, an accelerometer sensor may detect the magnitude of acceleration in all directions (typically three axes), and the magnitude and direction of gravity when stationary, and may be used for identifying a posture of the electronic device (e.g., horizontal and vertical screen switching, related games, magnetometer posture calibration), functions related to vibration recognition (e.g., pedometer, tapping), etc.; the sensor 905 may also comprise a fingerprint sensor, a pressure sensor, an iris sensor, a molecular sensor, a gyroscope, a barometer, a hygrometer, a thermometer, an infrared sensor, etc., which will not be repeated here.

The display unit 906 is configured to display information entered by or provided to the user. The display unit 906 may comprise the display panel 9061, and the display panel 9061 may be configured in the form of a Liquid Crystal Display (LCD), an Organic Light-Emitting Diode (OLED), etc.

The user input unit 907 may be configured to receive input numeric or character information, as well as to generate key signal input related to user settings and functional control of the electronic device. Specifically, the user input unit 907 comprises a touch panel 9071 as well as other input devices 9072. The touch panel 9071, also referred to as a touch screen, may collect the user's touch operations on or near it (e.g., the user's operations on or near the touch panel 9071 using any suitable object or accessory such as a finger and a stylus). The touch panel 9071 may comprise two parts: a touch detection device and a touch controller. The touch detection device detects the user's touch orientation and the signal brought by the touch operation and sends the signal to the touch controller; the touch controller receives the touch information from the touch detection device, converts it into contact coordinates, sends it to the processor 910, receives and executes the command from the processor 910. In addition, the touch panel 9071 may be implemented in various types, such as in a resistive type, in a capacitive type, in a infrared type, and in a surface-acoustic-wave type. In addition to the touch panel 9071, the user input unit 907 may also comprise other input devices 9072. Specifically, the input devices 9072 may comprise, but are not limited to, physical keyboards, function keys (such as volume control buttons and switch buttons), trackballs, mice, and joystick, which are not described in detail herein.

Further, the touch panel 9071 may be overlaid on the display panel 9061, and when a touch operation on or near the touch panel 9071 is detected, it is transmitted to the processor 910 to determine the type of touch event, and subsequently the processor 910 provides a corresponding visual output on the display panel 9061 based on the type of touch event. Although in FIG. 9, the touch panel 9071 and the display panel 9061 are used as two separate components to implement the input and output functions of the electronic device, in some embodiments, the touch panel 9071 may be integrated with the display panel 9061 to implement the input and output functions of the electronic device, specifically without limitation here.

The interface unit 908 is an interface for an external apparatus to connect to the electronic device 900. For example, the external apparatus may comprise a wired or wireless headset port, an external power (or a battery charger) port, a wired or wireless data port, a memory card port, a port for connecting to an apparatus having an identification module, an audio input/output (I/O) port, a video I/O port, a headset port, and so forth. The interface unit 908 may be configured to receive input from an external apparatus (e.g., data information, power) and transmit the received input to one or more components within the electronic device 900 or may be configured to transmit data between the electronic device 900 and the external apparatus.

The memory 909 may be configured to store software programs as well as various data. The memory 909 may primarily comprise a program memory area and a data memory area, wherein the program memory area may store an operating system, applications required for at least one function (e.g., a sound play function, an image play function, etc.), etc., and the data memory area may store data created based on use of the phone (e.g., audio data, phone book, etc.), etc. In addition, the memory 909 may comprise high-speed random-access memory, and may also comprise non-volatile memory, such as at least one disk memory device, flash memory device, or other volatile solid-state memory device.

The processor 910 is the control center of the electronic device and connects various parts of the entire electronic device using various interfaces and lines. The processor 910 performs various functions of the electronic device and processes data by running or executing software programs and/or modules stored in the memory 909 and calling data stored in the memory 909, so as to provide overall monitoring of the electronic device. The processor 910 may comprise one or more processing units. Preferably, the processor 910 may integrate an application processor and a modem processor, wherein the application processor primarily handles the operating system, user interface, and applications, etc., and the modem processor primarily handles wireless communications. It will be appreciated that the above-mentioned modem processor may also not be integrated into the processor 910.

The electronic device 900 may also comprise a power supply 911 (e.g., a battery) to power the various components, and preferably, the power supply 911 may be logically connected to the processor 910 through a power management system so that functions such as charging, discharging, and power consumption management are implemented through the power management system.

Preferably, embodiments of the present disclosure further provide an electronic device comprising a processor 910, a memory 909, a computer program stored on the memory 809 and runnable on the processor 910, which computer program when executed by the processor 810 implements various processes of the above-mentioned power supply method embodiments and may achieve the same technical effect. To avoid repetition, it will not be repeated here.

### Embodiment VI

Embodiments of the present application further provide a computer-readable storage medium storing a computer program. The computer program when executed by a processor, implements various processes of the above-mentioned powering method embodiments and can achieve the same technical effect. To avoid repetition, it will not be repeated here. The computer-readable storage medium can be, for example, Read-Only Memory (ROM), Random Access Memory (RAM), disk or CD-ROM, etc.

An embodiment of the present disclosure provides a computer-readable storage medium, for preparing a phase retarding apparatus. The phase retarding apparatus comprises a first polarization layer, a first phase retardation layer, a second phase retardation layer and a second polarization layer, wherein the first polarization layer is located on the side toward a light source for converting received light into linear polarized light, the first phase retardation layer is located on the side of the first polarization layer away from the light source for converting the linear polarized light into elliptical polarized light, the second phase retardation layer is located on the side of the first phase retardation layer away from the first polarization layer for converting the elliptical polarized light into linear polarized light, the second polarization layer is located on the side of the second phase retardation layer away from the first phase retardation layer for absorbing the linear polarized light. The birefringence of the first phase retardation layer and the second phase retardation layer does not decrease with increasing wavelength of visible light. At least one of the first phase retardation layer and the second phase retardation layer is a liquid crystal layer including negatively distributed liquid crystal. The distribution parameter of the negatively distributed liquid crystal satisfies a preset distribution range, and is determined by a target parameter of the negatively distributed liquid crystal at a plurality of different wavebands. The target parameter comprises one or more of the retardation amount and the birefringence. In this way, since the birefringence of the first phase retardation layer and the second phase retardation layer in this phase retarding apparatus does not decrease with increasing wavelength of visible light, the problem of dark-state light leakage in a preset viewing angle caused by the projection deviation of the polarization axes of the first polarization layer and the second polarization layer may be avoided at different wavebands, i.e., the displaying effect of the display using this phase retarding apparatus may be improved in the preset viewing angle at wide wavebands.

It should be understood by those skilled in the art that embodiments of the present disclosure may be provided as methods, systems, or computer program products. Accordingly, the present disclosure may take the form of an entirely hardware embodiment, an entirely software embodiment, or an embodiment combining software and hardware aspects. Further, the present disclosure may take the form of a computer program product implemented on one or more computer usable storage media (including, but not limited to, disk memory, CD-ROM, optical memory, etc.) containing computer usable program code therein.

The present disclosure is described with reference to flowcharts and/or block diagrams of methods, apparatuses (systems), and computer program products according to embodiments of the present disclosure. It should be understood that each process and/or block in the flowcharts and/or block diagrams, and the combination of processes and/or blocks in the flowcharts and/or block diagrams, may be implemented by computer program instructions. These computer program instructions may be provided to a processor of a general purpose computer, a specialized computer, an embedded processor, or other programmable data processing device to produce a machine such that the instructions executed by the processor of the computer or other programmable data processing device produce a device for implementing the functions specified in one process or multiple processes in the flowcharts and/or one block or multiple blocks in the block diagrams.

These computer program instructions may also be stored in a computer readable memory capable of directing a computer or other programmable data processing device to operate in a particular manner, such that the instructions stored in such computer readable memory produce an article of manufacture comprising an instruction device that implements the function specified in one or more processes of the flowcharts and/or one or more blocks of the block diagrams.

These computer program instructions may also be loaded onto a computer or other programmable data processing device such that a series of operational steps are executed on the computer or other programmable device to produce computer-implemented processing such that the instructions executed on the computer or other programmable device provide the steps used to perform the functions specified in one or more processes of the flowcharts and/or one or more blocks of the block diagrams.

In a typical configuration, a computing device comprises one or more processors (CPUs), input/output interfaces, network interfaces, and memory.

The memory may comprise non-permanent memory, random access memory (RAM) and/or non-volatile memory in the computer readable media, such as read-only memory (ROM) and flash memory. The memory is an example of a computer readable medium.

The computer readable media comprises permanent and non-permanent, removable and non-removable media. Any method or technology may be used to implement information storage. The information may be computer readable instructions, data structures, modules of a program, or other data. Examples of storage media for computers comprise, but are not limited to, Phase Change Random Access Memory (PRAM), Static Random Access Memory (SRAM), Dynamic Random Access Memory (DRAM), other types of Random Access Memory (RAM), Read-Only Memory (ROM), Electrically Erasable Programmable Read-Only Memory (EEPROM), flash memory or other memory technologies, Compact Disc Read-Only Memory (CD-ROM), Digital Versatile Disc (DVD) or other optical storage, magnetic cartridge tape, magnetic tape disk storage or other magnetic storage device or any other non-transport medium, and may be used to store information that may be accessed by the computing device. As defined herein, the computer readable media does not comprise transient computer readable media (transitory media), such as modulated data signals and carrier waves.

It is also important to note that the terms “include” “comprise” or any other variation thereof are intended to cover non-exclusive inclusion, such that a process, method, article, or apparatus that includes a set of elements includes not only those elements, but also other elements not expressly listed, or elements that are inherent to such process, method, article, or apparatus. Without further limitation, the inclusion of an element as defined by the statement “comprise one . . . ” does not preclude the existence of additional identical elements in the process, method, article, or apparatus including the element.

It should be understood by those skilled in the art that embodiments of the present disclosure may be provided as methods, systems, or computer program products. Accordingly, the present disclosure may take the form of an entirely hardware embodiment, an entirely software embodiment, or an embodiment combining software and hardware aspects. Further, the present disclosure may take the form of a computer program product implemented on one or more computer usable storage media (including, but not limited to, disk memory, CD-ROM, optical memory, etc.) containing computer usable program code therein.

The description above is only embodiments of the present disclosure and is not intended to limit the present disclosure. To a person skilled in the art, the present disclosure may be subject to various modifications and variations. Any modification, equivalent replacement, improvement, etc. made within the spirit and principle of the present disclosure shall be included in the scope of the claims of the present disclosure.

1. A phase retarding apparatus, characterized in that the phase retarding apparatus comprises a first polarization layer, a first phase retardation layer, a second phase retardation layer and a second polarization layer, wherein
the first polarization layer is located on the side toward a light source and is configured to convert received light into linear polarized light;
the first phase retardation layer is located on the side of the first polarization layer away from the light source and is configured to convert the linear polarized light to elliptical polarized light;
the second phase retardation layer is located on the side of the first phase retardation layer away from the first polarization layer and is configured to convert the elliptical polarized light to linear polarized light;
the second polarization layer is located on the side of the second phase retardation layer away from the first phase retardation layer and is configured to absorb the linear polarized light;
the birefringence of the first phase retardation layer and the second phase retardation layer does not decrease with increasing wavelength of visible light, at least one of the first phase retardation layer and the second phase retardation layer is a liquid crystal layer including negatively distributed liquid crystal, the distribution parameter of the negatively distributed liquid crystal satisfies a preset distribution range, and is determined by a target parameter of the negatively distributed liquid crystal in multiple different wave bands, and the target parameter comprises one or more of retardation amount, and birefringence.

2. The phase retarding apparatus according to claim 1, characterized in that the first phase retardation layer has refractive index satisfying N_{X}=N_{Y}<N_{Z}, wherein N_{X} is the refractive index of the first phase retardation layer in a direction of lagging phase axis, and N_{Y} is the refractive index of the first phase retardation layer in a direction of overrunning phase axis, and N_{Z} is an refractive index of the first phase retardation layer in a thickness direction; the second phase retardation layer has refractive index satisfying M_{X}>M_{Y}=M_{Z}, wherein M_{X} is the refractive index of the second phase retardation layer in a direction of lagging phase axis, and M_{Y} is the refractive index of the second phase retardation layer in a direction of overrunning phase axis, and M_{Z} is the refractive index of the second phase retardation layer in a thickness direction.

3. The phase retarding apparatus according to claim 2, characterized in that the negatively distributed liquid crystal is negatively distributed Reactive Mesogen.

4. The phase retarding apparatus according to claim 3, characterized in that the preset distribution range comprises a first subrange and a second subrange, wherein the first subrange is determined by the target parameters of the negatively distributed liquid crystal in a blue light waveband and in a green light waveband, while the second subrange is determined by the target parameters of the negatively distributed liquid crystal in an red light waveband and in the green light waveband.

5. The phase retarding apparatus according to claim 1, characterized in that the first phase retardation layer and the second phase retardation layer are liquid crystal layers including the negatively distributed liquid crystal, and the phase retarding apparatus further comprises a first alignment layer and a second alignment layer, wherein the first alignment layer is configured to align the negatively distributed liquid crystal included in the first phase retardation layer based on a first pre-tilt angle, and the second alignment layer is configured to align the negatively distributed liquid crystal included in the second phase retardation layer based on a second pre-tilt angle,
the first alignment layer is located between the first polarization layer and the first phase retardation layer, and the second alignment layer is located between the first phase retardation layer and the second phase retardation layer; or
the first alignment layer is located between the first phase retardation layer and the second phase retardation layer, and the second alignment layer is located between the second phase retardation layer and the second polarization layer.

6. The phase retarding apparatus according to claim 5, characterized in that the thickness of the first phase retardation layer is determined by the birefringence and the retardation amount of the first phase retardation layer in a preset waveband, and the thickness of the second phase retardation layer is determined by the birefringence and the retardation amount of the second phase retardation layer in a preset waveband.

7. The phase retarding apparatus according to claim 6, characterized in that an optical axis of the second phase retardation layer is parallel to a transmission axis of the first polarization layer.

8. The phase retarding apparatus according to claim 2, characterized in that one of the first phase retardation layer and the second phase retardation layer is a liquid crystal layer including the negatively distributed liquid crystal, and the other is a stretched film layer.

9. A display device, characterized in that the display device comprises the phase retarding apparatus according to any one of claims 1 to 8.

10. A preparation method for a phase retarding apparatus, characterized in that the method is applied to the phase retarding apparatus according to any one of claims 1 to 8, and the method comprises:
obtaining the retardation amount of a first phase retardation layer; and
determining the retardation amount of a second phase retardation layer corresponding to the retardation amount of the first phase retardation layer, based on a preset correspondence between the retardation amount of the first phase retardation layer and the retardation amount of the second phase retardation layer, to reduce dark-state light leakage in a preset viewing angle caused by projection deviation of polarization axes of a first polarization layer and a second polarization layer under the action of the first phase retardation layer and the second phase retardation layer.
